(19) United States
(12) Patent Application Publication
(10) Pub. No.: US 2025/0153135 A1
(43) Pub. Date: May 15, 2025

(54) INORGANIC SOLIDS MIXTURE

(71) Applicant: ARKEMA FRANCE, COLOMBES (FR)

(72) Inventors: Ludivine BOUVIER, Lacq (FR); Cecile LUTZ, Lacq (FR); Marie-Laurence LABEDE, Lacq (FR)

(21) Appl. No.: 18/725,574

(22) PCT Filed: Dec. 12, 2022
(86) PCT No.: PCT/FR2022/052310

§ 371 Date: Jun. 28, 2024

(30) Foreign Application Priority Data
Dec. 31, 2021 (FR) FR2114715

(51) Int. Cl. B01J 20/18; B01J 20/28; B01J 35/40

(52) U.S. Cl. CPC B01J 20/183; B01J 20/28016; B01J 35/40

(57) ABSTRACT

The present invention relates to mixtures comprising at least a first population P1 of inorganic solids of volume-average diameter VAD1 and a second population P2 of inorganic solids of volume-average diameter VAD2, the VAD2/VAD1 ratio of which is of between 0.10 and 0.60, limits included.

The present invention also relates to the use of said mixtures for catalytic reactions or separating or drying operations on gases and/or liquids.

The present invention relates to the field of zeolite agglomerates and more specifically to beds of zeolite agglomerates.

Industry today widely uses zeolite agglomerates in various fields, such as, for example, the separation, the purification, the drying, catalytic reactions, of gases or liquids. In these various techniques of separation, purification, drying or other catalytic reactions, the liquid or the gas is brought into more or less prolonged contact with said zeolite agglomerates. Techniques widely used today make use of beds of agglomerates through which the liquids or gases to be treated pass. These beds of agglomerates are most often loaded into columns, tubes, cartridges or other equivalent containers, making possible the entry of the liquid or gas to be treated and the evacuation of said liquid or gas after treatment. Furthermore, these containers have to be able to withstand more or less significant pressures which are intrinsic to the process employed.

Zeolite agglomerates are typically particles with a size which can range from a few tens of nanometres to a few tenths, indeed even hundreds, of millimetres. However, a recurring problem lies in the way and the techniques used to fill the containers, since it is desired to densify the beds of zeolite agglomerates in order to be able to have available, in a minimum of possible space, the greatest possible amount of zeolite agglomerates, that is to say to densify the beds of zeolite agglomerates, with the aim of improving still more the efficiency and the profitability of industrial installations.

To date, various processes or methods targeted at densifying such beds of zeolite agglomerates are already known. The common objectives targeted are a better occupation of the volume containing the zeolite agglomerates in order to maximize the amount of solid, this to be done in a reproducible way and as homogeneously and uniformly as possible, without penalizing the loading time. In the majority of cases, these are “mechanical” devices and processes, well known to a person skilled in the art, such as, for example:
a homogeneous distribution of the grains in a chamber, by virtue of a rain effect over the entire cross section of this chamber, as in the document U.S. Pat. No. 2,655,273,
fixed items of equipment, in which the particles are dispersed using compressed air, as in the document FR 2 288 560 A1,
rotating devices, which directly disperse the particles, as described in particular in the documents FR 2 087 890, FR 2 153 380 and FR 2 319 427 A1,
a mobile device, which comprises a shaft driven in rotation by a motor means and several stages of flexible deflecting elements, such as strips, as in the documents EP 007 854 A1 and EP 116 246 A1.

More specifically and among these devices known to a person skilled in the art, sock loading consists in manually pouring the solid particles using a flexible conduit, called “sleeve” or “sock”. Patent Application US2020353434 A1 thus describes a new sock system for sock loading which can take on a helical shape in order to limit the movement of the solid and thus to prevent its degradation.

Still other “high-density” loading techniques are described in the following documents:
FR 2 721 900, which describes in detail the Catapac® process, making it possible to achieve a loading density at least 10% greater than the sock-type loading described above,
EP 0 769 462 A1 and WO2006013240 A1, which teach the dense loading process now known under the name of Densicat®, combining a device and a process for the loading of a container with a divided solid and in particular for the loading of fixed beds of chemical or electrochemical, petroleum or petrochemical type with solids which can be provided in the form of beads, grains, cylinders, and the like.

More recently, increasingly sophisticated devices make possible the loading and unloading of zeolite agglomerates, as shown, for example, by the documents CN111634681 A and US2021146326 A1, which describe loading and unloading devices for adsorbents with highly specific feed systems.

In association with or as an alternative to these mechanical loading devices or processes, there also exist methods using lubricants in solid form. These methods are particularly employed in the pharmaceutical industry, the cosmetics industry, the food processing industry and the petrochemical industry with the aim of improving the flowability of mixtures of zeolite crystals or of zeolite agglomerates. This is because the flowability is a critical property for many processes, when these crystals or agglomerates have to pass, for example, through a feed hopper. Thus, and in order to guarantee a flow which is as fluid as possible and that tablets of homogeneous weight are obtained, most pharmaceutical processes today incorporate a preliminary stage of mixing with a lubricant. The latter is distributed at the surface of said crystals or agglomerates and thus improves their flowability.

To illustrate this technique, mention may be made, for example, of Application WO2019120938 A1, which describes a process for filling a chamber with solid particles which have been subjected beforehand to a pretreatment. This pretreatment consists in mixing said solid particles, before loading into the chamber, with at least one solid lubricant chosen from saturated fatty acids having 14 or more carbon atoms, their metal salts, esters, fatty alcohols having 14 or more carbon atoms, linear n-alkanes having 16 or more carbon atoms in solid form, fumaric acid, talc and sodium stearyl fumarate. The lubricant is introduced at ambient temperature, at a content of between 0.01% and 1% by weight, with respect to the total weight of the mixture of solid particles and of lubricant.

U.S. Pat. No. 7,927,555 B2 describes, for its part, a process for loading particles of catalysts comprising a specific liquid, such as water or organic compounds which have a boiling point of greater than 100° C. under 1 atmosphere.

These technologies having a solid or liquid lubricant exhibit, however, the disadvantage of requiring a stage of removal of said lubricant after the loading of the particles. This is because the lubricant might degrade the performance qualities or the efficiency of the adsorbents or catalysts. In addition, this technology may raise concerns about the presence of residual organic compounds, possibly leading to coking, deposits, clogging, and others.

Other methods of loading particles have been presented, in particular in the document WO2015107322, where catalyst particles are loaded radially into a column, on the one hand, and, on the other hand, particles of smaller size are loaded axially into this column. Patent EP 0 891 802 B1 provides a loader of particles which is intended to load particles into a container to form a bed of particles having outer and inner concentric layers, the particles of the inner and outer layers being different both in particle size and in composition.

These techniques, which can be described as “mechanical”, exhibit the disadvantage of requiring relatively complex devices for loading separate populations of particles, some in one specific arrangement, the others in another specific arrangement.

The present invention is targeted at overcoming the problems set out above encountered with the known loading methods of the prior art.

Thus, a first objective consists in providing a means making possible a dense and optimized loading of solid particles into a container, for example a column intended to receive solid particles, such as zeolite agglomerates or catalyst particles. Another objective consists in preventing filling front slopes, or at the very least in preventing filling front slopes of greater than 10%.

Another objective consists in increasing the amount of active phase in beds of zeolite agglomerates or of catalyst for a given volume in order to further improve the efficiency of said zeolite agglomerate or of said catalyst respectively.

The abovementioned objectives are achieved, wholly or at least in part, by virtue of the invention which follows. Still other objectives will become apparent in the description of the invention which is set out below.

This is because of the inventors have discovered a simple, economical and effective means making it possible to densify, that is to say render more dense, a set of particles loaded into a container, in particular to densify beds of zeolite agglomerates (also called molecular sieves), both fixed beds and simulated moving beds, commonly used in catalytic processes or adsorption or separation processes and preferably in adsorption-separation processes, but also beds of particles of catalysts.

Thus, and according to a first aspect, the present invention relates to a mixture comprising at least a first population P1 of inorganic solids of volume-average diameter VAD1 and a second population P2 of inorganic solids of volume-average diameter VAD2, the VAD2/VAD1 ratio of which is of between 0.10 and 0.60, limits included, preferably between 0.15 and 0.55, limits included, advantageously between 0.20 and 0.50, limits included, and more particularly between 0.25 and 0.50, limits included.

In one embodiment of the invention, the inorganic solids of the population P1 exhibit a volume-average diameter VAD1 of between 0.4 mm and 5 mm, preferably between 0.4 mm and 2.5 mm, more preferably between 0.4 mm and 1 mm and very particularly preferably between 0.4 mm and 0.8 mm, limits included.

The mixture according to the present invention generally and preferably comprises a population P2 of inorganic solids in an amount such that it does not lead to a substantial variability in the volume-average diameter of the mixture (VADm), compared to VAD1. More specifically, the mixture according to the invention exhibits a VADm/VAD1 ratio of greater than 0.85, preferably of greater than 0.88 and more preferably of greater than 0.90.

In a preferred embodiment of the present invention, the amount of inorganic solids of the second population P2 represents up to 25%, preferably up to 15%, for example from 0.5% to 25%, better from 1% to 15%, by weight, limits included, with respect to the combined P1+P2 inorganic solids.

In general, and while respecting the abovementioned ratio VAD2/VAD1, the inorganic solids of the population P2 exhibit a volume-average diameter VAD2 of less than 2 mm, preferably of less than 1 mm, more preferably of less than 0.5 mm, more particularly of less than 0.4 mm and typically of less than 0.3 mm. The volume-average diameter VAD2 is, according to a preferred aspect, greater than 0.05 mm and more preferably greater than 0.1 mm. Thus, and according to yet another preferred aspect, the volume-average diameter VAD2 is of between 0.05 mm and 2 mm, preferably between 0.05 mm and 1 mm, more preferably of between 0.05 mm and 0.5 mm, more particularly of between 0.1 mm and 0.4 mm, and typically between 0.1 mm and 0.3 mm, limits included.

In a particularly preferred embodiment of the invention, the latter relates to a mixture of inorganic solids consisting of at least two populations P1 and P2, as they have just been defined.

The inorganic solids of the populations P1 and P2 can be of any nature. The invention is, however, very particularly suitable for inorganic solids chosen from adsorbents in general, such as zeolites, aluminas, silica gels, and catalysts, and more particularly from zeolite agglomerates, also called molecular sieves, and solid catalysts, whether in the form of powders, beads, crushed materials, extrudates, spun yarns, moulded bodies or any other forms well known to a person skilled in the art, and preferably in the form of beads. Preference is given to zeolite agglomerates, also called molecular sieves, and among these to agglomerates of crystals of zeolite(s) with at least one binder which is organic or inorganic, preferably inorganic, for example a clay or a mixture of clays.

In a preferred embodiment of the mixture of the invention, the inorganic solids of the populations P1 and P2 are of identical chemical nature or at the very least sufficiently close, namely for the 2 populations to contribute to the same desired goal during the use of the mixture. According to an entirely preferred aspect, the inorganic solids of the populations P1 and P2 are of the same chemical nature.

Without wishing to be committed to a theory, it can be considered that the inorganic solids of the populations P1 and P2 act as “lubricant” in relation to each other, which leads to a reduction in the free space between the particles of the inorganic solids and thus to a densification of the mixture present in a container, in other words a gain in volume, compared to what is observed with a single population of inorganic solids P1 or a single population of inorganic solids P2.

The invention is particularly suitable for zeolite agglomerates and for solid particles of catalysts.

According to yet another preferred aspect of the present invention, the inorganic solids of the population P2 exhibit a mean roundness of greater than 60%, more preferably of greater than 80% and most preferably of greater than 90%.

The mean roundness, expressed as a percentage, is calculated as indicated in the document WO2008152319 from the moments of the distribution of the circles, inscribed in the particle, and tangent to the points of the contour of the particle, according to a complex filtering. It is representative of the variation in the radius of curvature of the particles and reflects the maturity of a solid in an abrasion process. Gentle bumps are more significant than very prominent bumps. The closer the shape of the particles is to perfect sphericity, the closer the roundness is to 100%.

In one embodiment, the mixture according to the invention advantageously exhibits a bed crushing strength typically of between a few hundred kPa and a few tens of MPa and is generally of between 0.3 MPa and 3.2 MPa, preferably between 0.3 MPa and 2.5 MPa. The method for measuring the bed crushing strength, and also the other analytical methods, are explained later in the description.

The mixture according to the invention is particularly well suited for adsorbent zeolite agglomerates, whether molecular sieves or particles of catalysts. The mixture of the invention is very particularly well suited to solid particles of zeolite agglomerates.

According to a preferred aspect, the mixture of the invention comprises or consists of inorganic solids which are agglomerates of crystals of zeolites well known to a person skilled in the art and already widely described in the scientific literature and the patent literature.

By way of non-limiting examples, the zeolite agglomerates included in the mixture of the present invention are agglomerates of crystals of zeolites, which zeolites are chosen from zeolites of LTA type, preferably 3A, 4A and 5A zeolites, zeolites of FAU type, preferably of X, LSX, MSX or Y type, zeolites of MFI type, preferably of ZSM-5 type and silicalites, zeolites P, zeolites of SOD type (such as sodalites), zeolites of MOR type, zeolites of CHA type (such as chabazites), zeolites of HEU type (such as clinoptilolites), and also homologues having hierarchical porosity, and mixtures of two or more of them in all proportions.

For the requirements of the present invention, preference is given to agglomerates of zeolites chosen from zeolites of LTA type, preferably 3A, 4A and 5A zeolites, zeolites of FAU type, preferably of X, LSX, MSX or Y type, zeolites P, zeolites of SOD type (such as sodalites), zeolites of MOR type, zeolites of CHA type (such as chabazites), zeolites of HEU type (such as clinoptilolites), and also homologues having hierarchical porosity, and mixtures of two or more of them in all proportions.

The abovesaid zeolites can be natural, artificial or synthetic, in other words natural, modified or synthesized. The zeolites generally contain one or more types of cations in order to ensure the electronic neutrality thereof. The cations present in the zeolites, naturally or after one or more cation exchanges, are well known to a person skilled in the art. Non-limiting examples of such cations comprise the cations of hydrogen, of alkali metals, of alkaline earth metals, of metals from Groups VIII, IB and IIB, and mixtures of two or more of them, and generally examples of cations comprise the cations of lithium, potassium, sodium, barium, calcium, silver, copper, zinc, and mixtures of two or more of them, in all proportions.

Very particularly preferred mixtures according to the invention comprise, by way of non-limiting examples, at least a first population P1 of zeolite agglomerates and at least a second population P2 of zeolite agglomerates, where the zeolite agglomerates are identical or different and are chosen from agglomerates of zeolites LTA (such as 3A, 4A or 5A), X, LSX, MSX and Y.

Specific examples of mixtures according to the invention comprise a mixture of agglomerates of zeolite LTA, for example of zeolite 3A and of zeolite 4A, or a mixture of agglomerates of zeolite 4A and of agglomerates of zeolite 5A, a mixture of agglomerates of zeolite LSX and of agglomerates of zeolite X, a mixture of agglomerates of zeolite MSX and of agglomerates of zeolite X, a mixture of agglomerates of zeolite LSX and of agglomerates of zeolite MSX, a mixture of agglomerates of zeolite X and of agglomerates of zeolite Y, a mixture of agglomerates of zeolite 4A and of agglomerates of zeolite X, to mention only some of them.

According to a preferred embodiment of the invention, the inorganic solids of the populations P1 and P2 are of the same nature, that is to say, and by way of non-limiting examples, form a mixture chosen from the group comprising mixtures of zeolite agglomerates based on zeolite LTA (for example mixtures of zeolite agglomerates based on zeolite 3A, mixtures of zeolite agglomerates based on zeolite 4A), mixtures of zeolite agglomerates based on zeolite LSX, mixtures of zeolite agglomerates based on zeolite MSX, mixtures of zeolite agglomerates based on zeolite X, mixtures of zeolite agglomerates based on zeolite Y, mixtures of zeolite agglomerates based on zeolite MFI, mixtures of zeolite agglomerates based on zeolite EMT, and others.

According to another embodiment of the invention, the inorganic solids of the populations P1 and P2 are of different nature, that is to say, and by way of non-limiting examples, form a mixture chosen from the group comprising mixtures of zeolite agglomerates based on zeolite X and of agglomerates based on zeolite LSX, mixtures of zeolite agglomerates based on zeolite X and of agglomerates based on zeolite MSX, mixtures of zeolite agglomerates based on zeolite MSX and of agglomerates based on zeolite LSX, mixtures of zeolite agglomerates based on zeolite X and of agglomerates based on zeolite Y, mixtures of zeolite agglomerates based on zeolite X and of agglomerates based on zeolite 4A, mixtures of zeolite agglomerates based on zeolite 4A and of agglomerates based on zeolite 5A, and others, to mention only some of them.

The mixture according to the invention can be prepared by any means well known to a person skilled in the art, for example by simple mechanical mixing of the inorganic solids of the populations P1 and P2, using a conventional stirrer, for example a blade agitator, or via a feed hopper with a common loading conduit, during the loading of said mixture directly into the desired container.

The mixture according to the invention makes it possible to respond, wholly or in part, to the disadvantages encountered in the prior art and very particularly makes it possible to improve the filling density of a container with inorganic solid particles, in particular as are defined above. The mixture of the invention thus makes it possible to densify a bed of solid inorganic particles while avoiding recourse to an organic lubricant which may prove to be difficult to remove and/or remain at least in part in said mixture. As indicated above, in the mixture according to the invention, the lubricating effect is observed by virtue of the specific ratio of the volume-average diameters of the populations P1 and P2.

According to a preferred embodiment, the mixture according to the present invention makes possible an increase in the packed density of the population of more than 2%, preferably of more than 5%, more preferably of more than 7%, advantageously of more by 10%, with respect to the packed density of the population P1.

Another advantage of the mixture of the invention lies in the fact that the preliminary mixing stage can be eliminated by loading the inorganic solids of the populations P1 and P2 concomitantly into the container. By virtue of the lubricating effect observed, the inorganic solid particles fill the container in a dense manner, without it being necessary to resort to other alternating filling techniques, radial/axial or other, nor by resorting to complex items of equipment targeted at filling the container homogeneously, as is often seen in the prior art.

The loading into a container of the mixture according to the invention can thus be carried out starting from the mixture of the inorganic solid particles of the populations P1 and P2, directly or also by concomitant loading, as indicated above. In some cases and if desired, it is possible to use one or more auxiliary means to help in the dense loading of the mixture according to the invention, such means being well known to a person skilled in the art and being able to be chosen, by way of non-limiting examples, from a vibrating means, a flexible sleeve, a means provided with blade(s), and others, in order to further improve the homogeneous distribution of the mixture according to the invention in the desired container. Such means are, however, generally not preferred, the mixture according to the invention exhibiting an entirely unexpected flowability, resulting in an ease of loading, in particular in a bed, not yet observed with the techniques described in the prior art.

It has furthermore been observed that the mixture according to the invention, with populations P1 and P2, the VAD2/VAD1 ratio of which is as claimed, has a positive impact on the mass transfer in the application (reduction of the mass transfer zone compared to that observed for the population P1). Specifically, it has been possible to observe, in some cases, a decrease in the bed porosity and without a significant increase in the pressure drop.

The mixture according to the present invention is particularly suitable for filling a container in an optimal manner, that is to say with an optimized amount of particles of inorganic solids per unit of volume. This effect of optimization of amount per unit of volume, in other words “densification”, is in particular due to the very good flowability of the mixture of the invention. This property can be observed for populations of inorganic solids of all sizes, as indicated above.

Furthermore, it has been possible to observe that the improved flowability, by virtue of the specific VAD1/VAD2 ratio set out above, prevents degradation during the loading of the mixture according to the invention, degradation often observed by attrition, grinding and others, in particular during passage through the loading hoppers.

The mixture according to the present invention also exhibits the advantage of being suitable for all sizes of container, whether this is a column, a tube, a reactor or other. The abovementioned good flowability properties of the mixture according to the invention ensure densification during filling and very good homogeneity of the filling, and make it possible to substantially optimize the hydrodynamics of the flows in the targeted applications.

The mixture according to the invention thus finds uses in numerous fields of application, whether in static mode or in dynamic mode, and for example, without limitation, for separations of gases and/or of liquids, for drying operations on gases and/or on liquids, separations of organic molecules, such as hydrocarbons for example, in the gas and/or liquid phase, catalytic reactions in the gas and/or liquid phase, and others.

The following examples illustrate the invention without, however, limiting the scope thereof, which is defined by the appended claims. The physical properties of the agglomerates according to the invention are evaluated by the methods known to a person skilled in the art, the main ones among which are restated below.

### Measurement Method

### Loss on Ignition (LOI):

The loss on ignition is determined in an oxidizing atmosphere, by calcination of the sample in air at a temperature of 950° C.±25° C., as described in Standard NF EN 196-2 (April 2006). The measurement standard deviation is less than 0.1%.

### Density:

The bulk density of the zeolite agglomerate material according to the present invention is measured as described in Standard DIN 8948/7.6 or Standard ASTM D4164 according to the size of the agglomerated material to be tested.

To determine the packed density, a given amount of the mixture of agglomerated beads is introduced into a 250 ml graduated measuring cylinder. The test specimen is placed in a tamping system (jolting system of JEL STAV 2003 Stampf type) and tamped for 10 minutes, i.e. 2400 jolts. That a constant volume has been obtained is confirmed with the addition of an additional 2 minutes of tamping. The filling density or packed density is subsequently calculated via the measurement of the weight of the mixture in the test specimen and the volume occupied. Before carrying out the measurements, the agglomerates are left to regain moisture in order to ensure that there is no variation in weight during the density measurement.

A measurement of loss on ignition, LOI, is carried out in order to be able to bring the density measurements back to an anhydrous value.

### Volume-Average Diameter of the Particles:

The volume-average diameter of an inorganic solid particle is determined by means of the CamSizer® appliance from Microtrac, by analysis of the particle size distribution of a sample of adsorbent material by imaging according to Standard ISO 13322-2:2006, using a conveyor belt making it possible for the sample to pass in front of the lens of the camera.

The volume-average diameter is subsequently calculated from the particle size distribution by applying Standard ISO 9276-2:2001. The accuracy is of the order of 0.01 mm for the range of volume-average diameters of the solid particles which can be used in the context of the present invention.

### Measurement of the Roundness:

For each sample tested, acquisitions are made on 10 000 particles by means of the Alpaga 500 Nano apparatus, and the elongation and roundness parameters are calculated for each particle. The mathematical tools used for their calculation are developed in the doctoral thesis of E. Pirard (1993, University of Liège, 253 pages) entitled “Morphométrie euclidienne des figures planes. Applications à l'analyse des matériaux granulaires” [Euclidean morphometry of flat figures. Applications in the analysis of granular materials]”. The document entitled “The descriptive and quantitative representation of particle shape and morphology” is available under the reference ISO/DIS 9276-6.

The mean roundness is expressed as a percentage and is calculated from the moments of the distribution of the circles inscribed in the particle, and which are tangent to the points of the contour of the particle, according to a complex filtering, as already indicated above. It is representative of the variation in the radius of curvature of the particles and reflects the maturity of a grain in an abrasion process. Gentle bumps are more significant than very prominent bumps. The closer the shape of the particles is to perfect sphericity, the closer the roundness is to 100%.

### Mechanical Strength:

The method selected to characterize the mechanical strength of the mixture of inorganic solids of the invention is Standard ASTM D 7084-04, which makes it possible to determine the crushing resistance of a solid bed. An increasing force is imposed in stationary phases via a piston on a sample of 20 cm³ of agglomerates placed in a metal cylinder of known internal section.

The fines obtained at the various stationary pressure phases are separated by sieving and weighed. The sieves used are suitable for agglomerates smaller than 1000 μm in size. Sieves of 200 μm, 80 μm and 40 μm are used for mixtures with volume-average diameters of respectively between 500 μm and 1000 μm, between 180 μm and 500 μm and between 50 μm and 180 μm.

On a graph representing the cumulative weight of fines obtained as a function of the force applied to the bed of mixture of solid particles, the bed crushing strength (BCS) is determined by interpolation of the applied load at 0.5% by weight of accumulated fines and calculation of the corresponding pressure in MPa, the interpolated force being with respect to the surface area of the internal section of the cylinder.

### EXAMPLES

### Example 1 (According to the Invention)

Two adsorbents are prepared from Faujasite zeolite crystals of X type, for which the number-average size of the crystals is 0.6 μm.

### Preparation of the Adsorbent 1 (Population P1):

A homogeneous mixture is prepared and 800 g of zeolite crystals are agglomerated with 160 g of kaolin (expressed as calcined equivalent) and 60 g of colloidal silica sold under the trade name Klebosol™ 30N50 (containing 30% by weight of SiO₂ and 0.5% by weight of Na₂O) in an Eirich nodulating mixer. The stirrer is started and water is gradually introduced until a moisture content of the mixture of approximately 36% is reached. The speed of the stirrer is adjusted in order to prepare beads with a mean size of approximately 0.7 mm. The agglomerates larger than 1 mm in size and the fines smaller than 0.315 mm in size are removed by sieving. The beads thus obtained are dried and then calcined at 550° C. (firing of the clay) under a stream of nitrogen for 2 hours. The volume-average diameter VAD1 of the beads obtained (Population P1) is 0.662 mm and the packed density (brought back to anhydrous) is 0.613.

### Preparation of the Adsorbent 2 (Population P2):

A second adsorbent is prepared according to the same protocol but while increasing the stirring speed in order to obtain agglomerates with a mean size close to 0.150 mm. The agglomerates are subsequently polished in a bowl granulator so as to form uniform beads. The selection by sieving is carried out so as to obtain beads with a size of between 0.08 mm and 0.180 mm. The beads are dried and then calcined at 550° C. (firing of the clay) under a stream of nitrogen for 2 hours. The volume-average diameter VAD2 of the beads obtained (Population P2) is 0.137 mm and the packed density (brought back to anhydrous) is 0.563.

### Characteristic of a Population P1+Population P2 Mixture:

A mixture of the Populations P1 and P2, in the proportions by weight of 90% of P1 and 10% of P2, is subsequently prepared in a Turbula helical mixer. The VAD2/VAD1 ratio is equal to 0.21.

The value of the Volume-Average Diameter of the mixture (VADm), according to the method described above, is quite close to the Volume-Average Diameter of the Population 1 (VAD1=0.662 mm), more specifically VADm/VAD1=0.87.

The packed density of the mixture is also measured and a gain of 10.7%, compared with the packed density observed for the Population 1, is noticed.

This example clearly shows that the mixture according to the invention makes it possible to substantially increase the packed density of a Population 1, while retaining a virtually unchanged volume-average diameter.

### Example 2 (According to the Invention)

An adsorbent 3 is prepared according to the same protocol as that used for the adsorbent 2 while also varying the stirring speed in order to obtain agglomerates with a mean size close to 0.20 mm. The agglomerates are subsequently polished in a bowl granulator so as to form uniform beads. The selection by sieving is carried out so as to obtain beads with a size of between 0.125 mm and 0.315 mm. The beads are dried and then calcined at 550° C. (firing of the clay) under a stream of nitrogen for 2 hours.

The volume-average diameters VAD2 of the beads obtained (Population P2) and their packed density (brought back to anhydrous) are 0.210 mm and 0.574 respectively.

### Characteristic of a Population P1+Population P2 (Adsorbent 3) Mixture:

A mixture of the Populations P1 (of example 1) and P2 (adsorbent 3 prepared above), in the proportions by weight of 90% of P1 and 10% of P2, is subsequently prepared in a Turbula helical mixer. The VAD2/VAD1 ratio is equal to 0.32.

The value of the Volume-Average Diameter of the mixture (VADm), according to the method described above, is quite close to the Volume-Average Diameter of the Population 1 (VAD1=0.662 mm), more specifically VADm/VAD1=0.89.

The packed density of the mixture is also measured and a gain of 9.4%, compared with the packed density observed for the Population 1, is noticed.

This example clearly shows that the mixture according to the invention makes it possible to substantially increase the packed density of a Population 1, while retaining a virtually unchanged volume-average diameter.

### Example 3 (According to the Invention)

A new adsorbent, adsorbent 4, is prepared in the same way as the adsorbents 2 and 3 above while also varying the stirring speed in order to obtain agglomerates with mean sizes of close to 0.30 mm. After passage of the agglomerates in the drum granulator, the selection by sieving is carried out so as to obtain beads with a size of between 0.18 mm and 0.40 mm. The beads are dried and then calcined at 550° C. (firing of the clay) under a stream of nitrogen for 2 hours. The volume-average diameter VAD2 of the beads obtained (Population P2) and their packed density (brought back to anhydrous) are 0.318 mm and 0.606 respectively.

### Characteristic of a Population P1+Population P2 (Adsorbent 4) Mixture:

A mixture of the Populations P1 (of example 1) and P2 (adsorbent 4), in the proportions by weight of 90% of P1 and 20% of P2, is subsequently prepared in a Turbula helical mixer. The VAD2/VAD1 ratio is equal to 0.48.

The value of the Volume-Average Diameter of the mixture (VADm), according to the method described above, is quite close to the Volume-Average Diameter of the Population 1 (VAD1=0.662 mm), more specifically VADm/VAD1=0.89.

The packed density of the mixture is also measured and a gain of 7.1%, compared with the packed density observed for the Population 1, is noticed.

This example clearly shows that the mixture according to the invention makes it possible to substantially increase the packed density of a Population 1, while retaining a virtually unchanged volume-average diameter.

### Comparative Example 1

Another adsorbent is prepared according to the same protocol (according to the protocols described above for the adsorbents 3 and 4) while varying the stirring speed in order to obtain agglomerates with mean sizes close to 0.45 mm.

The agglomerates are subsequently polished in a drum granulator so as to form uniform beads. The selection by sieving is carried out so as to obtain beads with a size of between 0.40 mm and 0.50 mm. The beads are dried and then calcined at 550° C. (firing of the clay) under a stream of nitrogen for 2 hours.

The volume-average diameter VAD2 of the beads obtained (Population P2) and their packed density (brought back to anhydrous) are respectively 0.441 mm and 0.607.

Characteristic of a Population P1+Population P2 (Comp. Adsorbent 1) Mixture:

A mixture of the Populations P1 and P2 (comp. 1), in the proportions by weight of 90% of P1 and 10% of P2, is subsequently prepared in a Turbula helical mixer. The VAD2/VAD1 ratio is equal to 0.67.

The value of the Volume-Average Diameter of the mixture (VADm), according to the method described above, is virtually identical to that of the Volume-Average Diameter of the Population 1 (VAD1=0.662 mm), more specifically VADm/VAD1=0.97.

The packed density of the mixture is also measured and it is noticed that there is no gain, indeed even a loss in density of −0.4%, compared with the packed density observed for the Population 1.

The values obtained in examples 1, 2 and 3 and comparative example 1 are collated in table 1 below.

TABLE 1

| | | | | Ratio by |
|---|---|---|---|---|
| | | Gain in | | weight |
| Example | VAD2/VAD1 | DT (%) | VADm/VAD1 | P2/(P1 + P2) |
| 1 | 0.21 | 10.7 | 0.87 | 10% |
| 2 | 0.32 | 9.4 | 0.89 | 10% |
| 3 | 0.48 | 7.1 | 0.89 | 20% |
| Comparative | 0.67 | −0.4 | 0.97 | 10% |
| example 1 | | | | |

1. Mixture comprising at least a first population P1 of inorganic solids of volume-average diameter VAD1 and a second population P2 of inorganic solids of volume-average diameter VAD2, the VAD2/VAD1 ratio of which is of between 0.10 and 0.60, limits included, preferably between 0.15 and 0.55, limits included, advantageously between 0.20 and 0.50, limits included, and more particularly between 0.25 and 0.50, limits included.

2. Mixture according to claim 1, in which the inorganic solids of the population P1 exhibit a volume-average diameter VAD1 of between 0.4 mm and 5 mm, preferably between 0.4 mm and 2.5 mm, more preferably between 0.4 mm and 1 mm and very particularly preferably between 0.4 mm and 0.8 mm, limits included.

3. Mixture according to claim 1 or claim 2, in which the VADm/VAD1 ratio is greater than 0.85, preferably greater than 0.88 and more preferably greater than 0.90, where VADm represents the volume-average diameter of said mixture.

4. Mixture according to any one of the preceding claims, in which the amount of inorganic solids of the second population P2 represents up to 25%, preferably up to 15%, for example from 0.5% to 25%, better from 1% to 15%, by weight, limits included, with respect to the combined P1+P2 inorganic solids.

5. Mixture according to any one of the preceding claims, in which the volume-average diameter of the inorganic solids of the population P2 is less than 2 mm, preferably less than 1 mm, more preferably less than 0.5 mm, more particularly less than 0.4 mm and typically less than 0.3 mm.

6. Mixture according to any one of the preceding claims, in which the volume-average diameter of the inorganic solids of the population P2 is greater than 0.05 mm and more preferably greater than 0.1 mm.

7. Mixture according to any one of the preceding claims, in which the inorganic solids are chosen from adsorbents, and catalysts, and more particularly from zeolite agglomerates, also called molecular sieves, and solid catalysts, whether in the form of powders, crushed materials, extrudates, spun yarns, moulded bodies or any other form.

8. Mixture according to any one of the preceding claims, in which the inorganic solids are agglomerates of crystals of zeolites, said zeolites being chosen from zeolites of LTA type, preferably 3A, 4A and 5A zeolites, zeolites of FAU type, preferably of X, LSX, MSX or Y type, zeolites of MFI type, preferably of ZSM-5 type and silicalites, zeolites P, zeolites of SOD type, zeolites of MOR type, zeolites of CHA type, zeolites of HEU type, and also homologues having hierarchical porosity, and mixtures of two or more of them in all proportions.

9. Mixture according to any one of the preceding claims, chosen from mixtures of at least a first population P1 of zeolite agglomerates and of at least a second population P2 of zeolite agglomerates, where the zeolite agglomerates are identical or different and are chosen from agglomerates of zeolites LTA (such as 3A, 4A or 5A), X, LSX, MSX and Y.

10. Use of a mixture according to any one of the preceding claims, in static mode or in dynamic mode, for separations of gases and/or of liquids, for drying operations on gases and/or on liquids, separations of organic molecules, in the gas and/or liquid phase, catalytic reactions in the gas and/or liquid phase, and others.
